(19) United States
(12) Patent Application Publication
(10) Pub. No.: US 2004/0078325 A1
(43) Pub. Date: Apr. 22, 2004

(54) Managing activation/deactivation of transaction accounts enabling temporary use of those accounts

(75) Inventor: James A. O'Connor, Ulster Park, NY (US)

Correspondence Address: HESLIN ROTHENBERG FARLEY & MESITI PC, 5 COLUMBIA CIRCLE, ALBANY, NY, 12203, US

(73) Assignee: International Business Machines Corporation, Armonk, NY

(21) Appl. No.: 10/274,622

(22) Filed: Oct. 21, 2002

(51) Int. Cl. G06F 17/60

(52) U.S. Cl. 705/39

(57) ABSTRACT

Activation and deactivation of transaction accounts are managed to enable temporary use of those accounts. A transaction account is activated to enable use of the account. In response to activation, the account is temporarily available for a defined window. Upon expiration of the window, the transaction account is deactivated.

### TECHNICAL FIELD

This invention relates, in general, to the managing of transaction accounts, and in particular, to managing the activation/deactivation of the transaction accounts to provide temporary use of those accounts.

### BACKGROUND OF THE INVENTION

A transaction account is an account used by a user to conduct business, including, for example, the exchange or transfer of goods, services and/or funds. Associated with a transaction account is transaction account information including, for instance, sensitive data, which if accessed by an unauthorized party, may result in a fraudulent transaction. One prevalent type of fraudulent transaction is Internet credit card fraud. Internet credit card fraud occurs when an unauthorized party obtains a credit card account number and other relevant information and then uses such information to make a credit card purchase via the Internet. Thus, Internet credit card fraud has two phases. The first phase is the acquisition phase, during which the fraudulent purchaser acquires the credit card account number and other relevant information. The second phase, the usage phase, includes using the credit card information over the Internet to make a fraudulent purchase.

Typical methods of protecting against Internet credit card fraud focus on the acquisition phase. Intercepting data transmitted over the Internet is relatively easy because the Internet is designed for open and easy access. To protect data, such as credit card information, during its transmission, encryption and access key systems have been employed to prevent unauthorized acquisition. One such encryption system is Netscape's Secure Socket Layer (SSL).

Encryption and access key systems, however, offer protection only during the transmission of data. Credit card information is still vulnerable to unauthorized acquisition, while it is stored on merchants' computers and when it is presented during non-Internet transactions (e.g., in-person, mail, and telephone transactions). Obtaining credit card information under these circumstances allows the fraudulent purchaser to move to the usage phase and complete an Internet purchase.

Once at the usage phase, a fraudulent purchase can be completed relatively easily, especially because Internet-based purchases lack a requirement for a signature or the presentation of the credit card itself or identification documents. Existing systems implement authentication techniques to provide some protection against fraud at the usage phase. For example, Verified by Visa incorporates a passcode system whereby a customer must enter a personal identification code before completing an Internet-based transaction. This system, however, burdens the customer with a code to remember. More importantly, the identification code is still at risk of being intercepted, if transmitted over an unencrypted system. Once intercepted, the fraudulent purchaser merely adds it to the collection of credit card information used to make a purchase.

Accordingly, a need exists for an enhanced capability to protect transaction accounts against, for example, fraudulent use of those accounts. As one example, a need exists for a capability that manages activation/deactivation of transaction accounts, which enables temporary use of those accounts.

### SUMMARY OF THE INVENTION

The shortcomings of the prior art are overcome and additional advantages are provided through the provision of a method of managing activation of transaction accounts. The method includes, for instance, activating a transaction account to enable use of the transaction account, wherein the transaction account is temporarily available for a defined window; and deactivating the transaction account, in response to being outside the defined window.

In a further aspect of the present invention, a method of managing activation of transaction accounts is provided. The method includes, for instance, activating a transaction account to enable use of the transaction account; temporarily deactivating the transaction account; and repeating the activating and the temporarily deactivating one or more times within a life of the transaction account.

System and computer program products corresponding to the above-summarized methods are also described and claimed herein.

Various features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a communications environment incorporating and using one or more aspects of the present invention;

FIG. 2 depicts one embodiment of a communications environment including an Internet Service Provider network, in accordance with one or more aspects of the present invention;

FIG. 3 depicts one embodiment of a communications environment, wherein activation of a transaction account is managed in accordance with one or more aspects of the present invention; and

FIGS. 4a-4b depict one embodiment of the logic associated with activation of a transaction account in the communications environment of FIG. 3, in accordance with one or more aspects of the present invention.

### BEST MODE FOR CARRYING OUT THE INVENTION

In one aspect of the present invention, activation of transaction accounts is managed. As used herein, a transaction account is any type of account used, for instance, in the purchase, lease, exchange or transfer of goods, services, funds, etc. In one example, a transaction account is temporarily activated and deactivated according to parameters of a defined window. While activated during the defined window, the transaction account is enabled to be used by the owner of the account. Upon expiration of the defined window, the transaction account is unavailable for use until it is activated again.

Although described herein in one embodiment in connection with credit card transaction accounts used for purchases via the Internet, the concepts presented are applicable to other types of transactions and transaction accounts. For example, the concepts are applicable to transmissions of other sensitive information that are susceptible to unauthorized acquisition and use. Examples of such other transmissions include, for instance, on-line debit card and stock transactions, as well as in-store credit card or debit card purchases or telephone purchases.

Management of the activation of transaction accounts, as embodied in one aspect of the present invention, can facilitate the prevention of misuse of the transaction account. Such misuse includes, for example, a fraudulent Internet-based credit card purchase by a party who gained access to credit card information. Since the Internet is designed for wide and easy access, unprotected information can be easily intercepted. When a party captures credit card information and uses it on the Internet to make a purchase, it is called Internet credit card fraud. The activation management technique disclosed herein presents a way to at least minimize the risk of Internet credit card fraud. Other types of misuses can also be minimized.

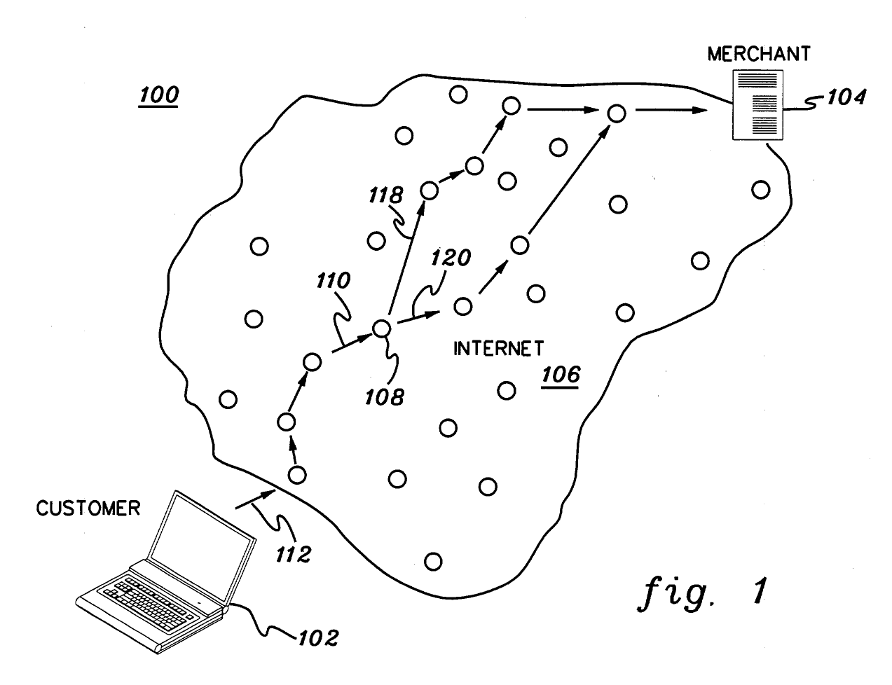

One embodiment of a communications environment incorporating and using one or more aspects of the present invention is described with reference to FIG. 1. A communications environment 100 includes, for instance, a customer unit 102 coupled to a merchant unit 104 via, for instance, a network 106, such as the Internet. As one example, customer's unit 102 is coupled to merchant's unit 104 via a plurality of nodes 108 and one or more connection pathways 110 of Internet 106. As examples, a node can be any of various devices including, but not limited to, routers, bridges, gateways, and servers running various operating systems and application programs. Examples of such equipment include Enterprise Systems Architecture/390 and Application System/400 computers available from International Business Machines Corporation, Armonk, N.Y. An Internet connection 112 couples the customer's computer to Internet 106 through one of nodes 108.

As examples, customer's unit 102 is an intelligent workstation, personal computer, such as an Aptiva PS/1 or NetVista, a portable computer (e.g., laptop computer), or ThinkPad available from International Business Machines Corporation, Armonk, N.Y., that includes an operating system (e.g., OS/2, Linux, Unix or Microsoft Windows) and browser software (e.g., Netscape Navigator or Microsoft Explorer). Typically, application software is installed on the customer's computer to provide the capability to connect to the node that allows access to the Internet. Advantageously, customer unit 102 tan be a mobile computing unit, so that activation and/or deactivation of transaction accounts can be managed with little or no restrictions related to the location or movement of the customer. Furthermore, the activation/deactivation of a transaction account does not have to be tethered to one particular computer or software environment. A user's transaction account can be activated by the user from any location where a portable computer can gain access to the transaction account, or by using someone else's computer. For example, rather than logging on at home, a user with an America OnLine (AOL) account can log onto that AOL account using a laptop remotely, or by using someone else's computer. If the AOL account had been set up to temporarily activate the user's transaction account, the user could then use the transaction account, just as if the user had logged on from the home-based computer.

A representative merchant's computer is, for instance, a RISC System 6000 computer available from International Business Machines Corporation, Armonk, N.Y., that includes the AIX (Advanced Interactive Executive) Operating System and a server program, such as Netscape Enterprise Server.

Internet 106 employs, for instance, Transmission Control Protocol/Internet Protocol (TCP/IP) to transmit data over its packet-switched network. TCP breaks up data sent over Internet 106 into packets and reassembles the packets at their destinations, while IP ensures that the packets are sent to the correct destinations. Every source and destination on the Internet has a unique IP address. IP addresses correspond to more easily remembered domain names. Domains are groups of computers on the Internet. A router examines the destination address of a data packet and sends it in the most efficient way to another router. This process repeats until the packet arrives at its destination.

In addition, Internet 106 provides a client/server structure called the World Wide Web (“web”). The web allows the customer's computer to access text, graphics, sound, video and interactive multimedia that reside on virtual sites (websites). Websites are constructed by a language such as Hyper Text Markup Language (HTML), which has commands that instruct a browser to display text, graphics, and multimedia files on virtual pages (web pages). The HTML commands also allow a user's computer running browser software to move from one web page to another using hypertext links. The unique identifier for a web page is a Universal Resource Locator (URL). The first part of a URL indicates the type of transfer protocol used to retrieve files (e.g., http). A URL may also indicate the country in which the merchant resides.

To conduct a transaction with a merchant associated with merchant's unit 104, a customer first uses customer's unit 102 to establish a connection 112 to the Internet through a node. Customer's unit 102 then initiates a communication session with merchant's unit 104, thereby accessing the merchant's website (not shown) through browser software residing on the customer's unit. The customer transmits data, such as credit card information, to the merchant's unit using TCP/IP. By means of the TCP/IP protocol, the data is transmitted as packets over the connection pathways to nodes. Although data packets may have a common destination, each packet may be transmitted over a different set of paths and through a different set of routing nodes. For example, in FIG. 1, one of the packets flows over a connection pathway 118 and the next flows over a pathway 120, yet both ultimately arrive at merchant's unit 104. The particular path taken by a data packet cannot be predicted in advance. This inability to predict the path and know in advance the particular equipment that will act as the routing nodes partly explains why the Internet is an inherently insecure environment for transactions. The administrator of a node might capture, examine, or tamper with unprotected data being transmitted through that node.

The data transmitted in FIG. 1 could be protected from interception by a technique that uses encryption and access keys (e.g., SSL). An encryption and access key strategy, however, provides no protection against fraudulent use once an unauthorized party has obtained sensitive data, such as credit card information. Further, acquisition of sensitive information can occur when such information is stored, for example, on the merchant's computer. Such electronically stored information is at risk of being captured by a hacker or an unscrupulous employee of the merchant. Of course, as the number of merchant servers where the sensitive information resides increases, the risk of unauthorized capture also increases.

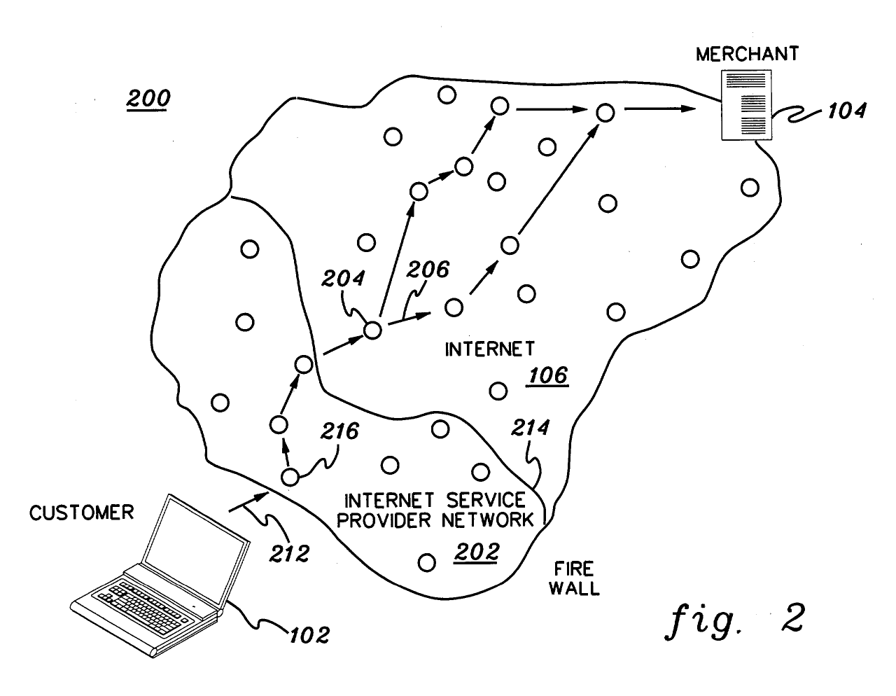

Another embodiment of a communications environment incorporating and using one or more aspects of the present invention is described with reference to FIG. 2. A communications environment 200 includes customer's unit 102 coupled to merchant's unit 104 via Internet 106, which includes an Internet Service Provider (ISP) network 202. Customer's unit 102 is coupled to merchant's unit 104 via a plurality of nodes (e.g., 204) and one or more connection pathways 206 of Internet 106. One or more of the nodes reside in ISP network 202 and one or more of the connection pathways connect a node residing in the ISP network to a node residing in a portion of the Internet that is outside the ISP network. Further, customer's unit 102 is coupled to ISP network 202 via a connection 212. ISP network 202 includes a firewall 214, in one example.

ISPs run their own segment of Internet 106 and include, for example, America Online and CompuServe. A user of ISP network 202 establishes an account with the ISP by, for example, paying a fee. The ISP typically supplies a client application program that is installed on a customer's unit 102. Application software is also installed on an ISP network node (e.g., node 216) that allows the customer to gain access to the ISP network, while preventing unauthorized access via the firewall. This software provides for authentication techniques to minimize unauthorized access to ISP network 202, and may include, for example, a logon procedure that requires a user ID and PIN (personal identification number) or password.

The functioning and exemplary embodiments of the nodes in FIG. 2 are similar to those discussed above in relation to FIG. 1. Firewall 214 can be implemented by, for example, Check Point VPN-1/Firewall-1, Cisco PIX, or SecureWay, offered by International Business Machines Corporation, Armonk, N.Y.

Connection 212 can utilize a traditional phone line modem connection using either Serial Line Internet Protocol (SLIP) or Point-to-Point Protocol (PPP). Other examples of communication services that could be used by connection 212 include, but are not limited to, digital subscriber line (DSL), Integrated Services Digital Network (ISDN), cable modem, satellite connection, and direct local area network (LAN) connection. Connection 212 typically uses data encryption or a secure protocol, such as SSL, to prevent unauthorized interception, examination or tampering of data transmitted between customer's unit 102 and ISP network 202.

In FIG. 2, before a customer operating customer's unit 102 conducts an on-line transaction with a merchant associated with merchant's unit 104, the customer pays a fee and establishes an account with the ISP. The customer's unit establishes connection 212 with ISP network 202. To access ISP network 202, the customer is authenticated by logging on with a User ID and password via customer's unit 102. After successfully logging onto the ISP network, the customer's unit has access to Internet 106 via the ISP network. Through this Internet access, the customer conducts a transaction with the merchant by transmission of data packets similar to the transmission described above in relation to FIG. 1.

In contrast to the substantially free flowing data shown in FIG. 1, the flow of data in FIG. 2 is more restricted. In addition to allowing only authorized users to access the resources of the ISP network, ISP network 202 employs firewall 214 to monitor and impede some Internet 106 data from entering the ISP network. For example, the firewall may screen data packets and allow only those with previously specified domain names and IP addresses to enter the ISP network. Despite these restrictions, once data packets leave the firewall-protected boundary of the ISP network, they face the same risk of interception that was discussed above in relation to FIG. 1.

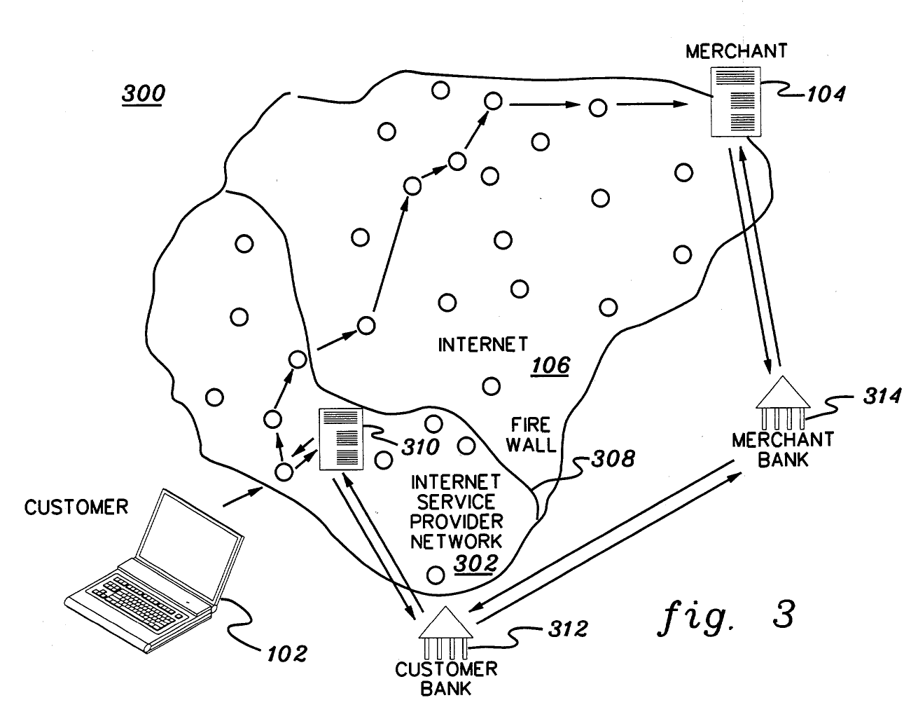

Another embodiment of a communications environment incorporating and using one or more aspects of the present invention is described with reference to FIG. 3. In this embodiment, a communications environment 300 includes customer's unit 102 coupled to merchant's unit 104 via Internet 106, which includes an Internet Service Provider network 302, similar to the environment described with reference to FIG. 2. Again, ISP network 302 includes a firewall 308. Additionally, in this embodiment, ISP 302 includes an ISP unit 310 coupled to a customer's financial institution unit 312. Customer's financial institution unit 312 is coupled to a merchant's financial institution unit 314, which, in turn, is coupled to merchant's unit 104. An example of the customer's or merchant's financial institution unit includes a mainframe server, such as a zSeries 900 computer, available from International Business Machines Corporation, Armonk, N.Y.

In one example, a customer using customer's unit 102 conducts an Internet-based credit card transaction with a merchant associated with merchant's unit 104. In accordance with an aspect of the present invention, the account associated with this transaction is temporarily activated for a defined window. The temporary availability of the account during the defined window is for a period of time which is, for example, less than the life of the account.

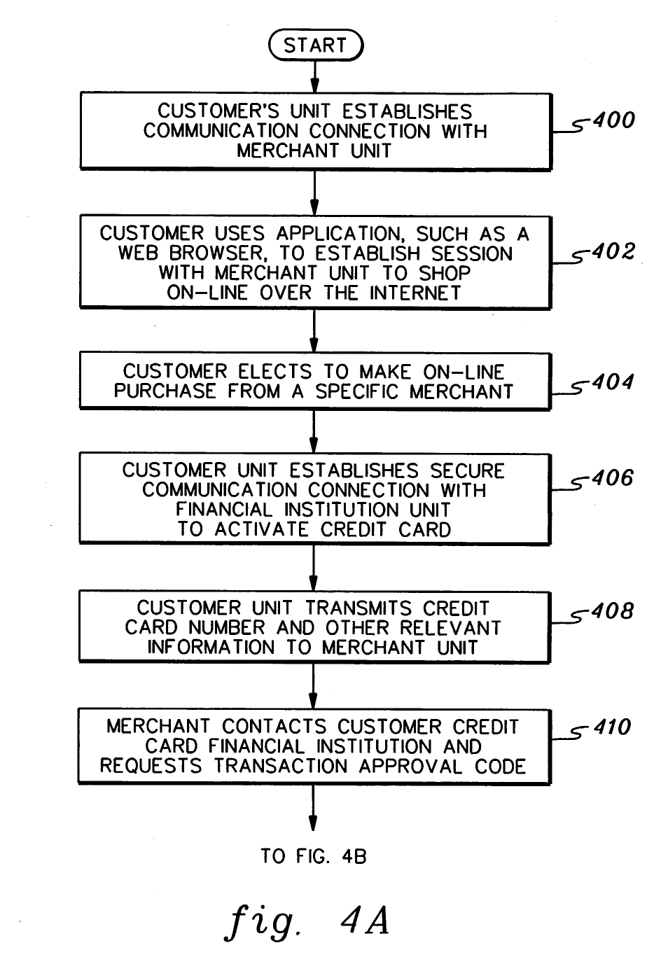

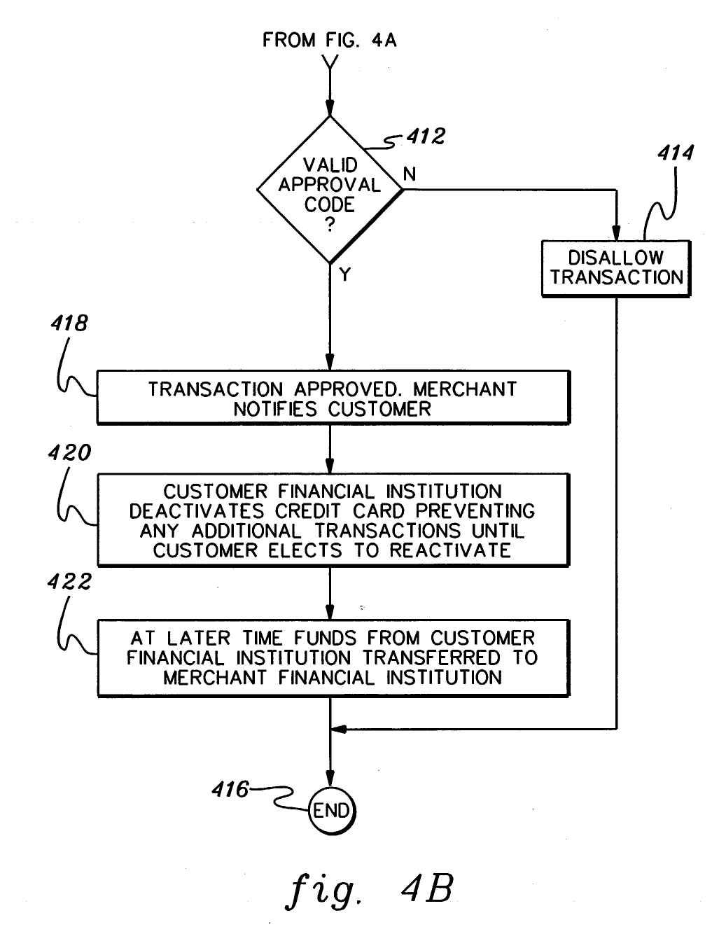

One embodiment of the logic associated with managing the activation/deactivation of a transaction account in an environment, such as the one depicted in FIG. 3, is described in detail with reference to FIGS. 4a and 4b.

Initially, the customer's unit establishes a communication connection with the merchant's unit, STEP 400 (FIG. 4a). For example, customer's unit 102 first establishes a communication session with ISP network 302, and then, establishes a communication session with merchant's unit 104, as described in relation to FIG. 2.

Thereafter, using an application, such as a web browser, the customer establishes an Internet-based shopping session with the merchant's unit, STEP 402. In response to the customer electing to make an on-line purchase from a specific merchant, STEP 404, the customer's unit, via ISP unit 310, establishes a secure communication connection with the unit of the customer's financial institution to activate the credit card account, STEP 406. Examples of such secure communication sessions include transmitting information over public switched telephone network (PSTN) lines using an encryption technique together with a personal identification number or password, over a private network, or over Internet 106 using a protection technique such as SSL or SET. SET, developed in part by International Business Machines Corporation, is a technique for ensuring secure transactions by requiring both customers and merchants to be enabled and registered. As another example, this secure communication session may be implemented by having customer's financial institution unit 312 reside within firewall 308.

The account is activated by, for instance, requesting such activation. The activation of the credit card account creates a defined window, referred to herein as a Momentary Unique Transaction Event (MUTE) window. The MUTE window is defined by parameters (e.g., completion of a transaction, time period, etc.) specified by, for example, the owner of the account. For the duration of the MUTE window, the credit card account is available for use. The secure communication session ensures that only the credit card account owner can activate the account prior to the purchase.

After the credit card account is activated by the opening of the MUTE window, the data used to process the transaction (e.g., the credit card number and other relevant information) is communicated between the customer's unit and the merchant's unit, STEP 408. In this simplified example, data packets transmitted between the customer's unit and the merchant's unit flow through the same series of nodes and connection pathways. However, in other examples, each data packet may be transmitted over a different route, which includes a different set of nodes and connection pathways on the Internet.

Upon receipt of the information, the merchant contacts the merchant's financial institution, which, in turn, contacts the customer's financial institution in an attempt to obtain an approval code, STEP 410. These contacts may be performed electronically. For example, merchant's unit 104 may communicate with merchant's financial institution unit 314 and/or merchant's financial institution unit 104 may communicate with customer's financial institution unit 312. These electronic communications may be implemented by, for example, point-of-sale terminals and secure communications over the Internet. Such communications may also be implemented by non-automated methods. For example, an individual monitoring the merchant's unit may request an approval code via the Public Switched Telephone Network (PSTN).

If a MUTE window is not in existence, the credit card account is not available for use and the customer's financial institution transmits a code disapproving the transaction. If a valid approval code is not received from the financial institution, INQUIRY 412 (FIG. 4b), then the transaction is not allowed, STEP 414, and the transaction ends, STEP 416, with the customer not allowed to make the purchase. However, if a valid approval code is received, INQUIRY 412, then the transaction is approved and the merchant notifies the customer, STEP 418. For example, the customer's financial institution unit 312 communicates an approval code that is ultimately received by the merchant, via merchant's financial institution unit 314 and merchant's unit 104.

In one example, immediately after transmitting the approval code to the merchant, the customer's financial institution deactivates the credit card account, preventing any further transactions from taking place until the customer elects to reactivate the account to make another purchase, STEP 420. In a further example, the account is deactivated after a predetermined amount of time or based on other criteria.

Some time later, funds from the customer's financial institution are transferred to the merchant's financial institution, STEP 422, completing the transaction, STEP 416.

In the above example, the transaction is considered complete when the merchant transmits the approval code, and thus, the MUTE window is automatically closed thereafter. However, in other examples, a transaction can be considered complete at other transaction processing steps. Further, in yet another example, a transaction is considered complete after a predefined amount of time (even if the transaction has not be commenced, but the window is open), in order to cause the MUTE window to be closed. This ensures that the window is temporarily available and prevents the window from being left open inadvertently. Other examples are also possible to provide a temporary window, and these are considered a part of the claimed invention.

Unlike calling cards, gift cards or similar cards, the deactivation of the transaction account, as described above, is temporary. As an example of this temporary characteristic, the activation and deactivation processes can be repeated one or more times within the life of the transaction account (e.g., before expiration or permanent deactivation). For example, if an account has an expiration date two years from the current date, then the account can be activated/deactivated one or more times before the expiration or permanent deactivation of the account.

Described in detail above is a capability for managing the activation and deactivation of a transaction account in a manner that allows use of that account only during a defined window. By restricting availability of the account to a relatively brief, user-defined window, fraudulent use is deterred, even when a party has previously gained access to transaction account information. This technique deters fraudulent use of the transaction account because it is unlikely that an attempt to use the transaction account for fraudulent purposes will occur while the account is activated during a brief MUTE window. As long as the account is not activated, no transactions will be approved. The present invention provides this advantage of fraud deterrence through account activation/deactivation without the need for elaborate encryption or random number generating techniques and the processing overhead associated with such techniques. Furthermore, since the present invention utilizes only one secure communication connection (i.e., between the customer and the customer's financial institution), Internet-based transactions may be performed without regard for the level of security implemented at merchant's websites.

The following example illustrates how an aspect of the invention can prevent a fraudulent purchase. It is assumed that a customer using customer's unit 102 has elected to make a credit card purchase as previously described and no data security technique affects the communications between customer's unit 102 and merchant's unit 104. Furthermore, it is assumed that deactivation of the credit card account occurs automatically after a single purchase is complete. In this example, the data packets traverse a particular node, providing the administrator of that node the opportunity to acquire the customer's credit card information. After obtaining the customer's credit card information, the administrator of that node accesses a website of another merchant and attempts to make a fraudulent purchase. This attempt occurs after the customer completes a valid purchase. However, in accordance with an aspect of the present invention, when the other merchant requests an approval code, no such code will be transmitted because after completion of the valid purchase, the MUTE window is closed and the credit card account is deactivated.

In a related example, in which credit card account deactivation is again implemented to occur automatically after a single purchase is complete, the attempted fraudulent purchase is concluded fast enough to successfully use the activated account prior to the completion of the valid purchase by the customer. In this case, the customer's attempted purchase does not result in an approval code because the account is deactivated after the fraudulent purchase. Upon failing to obtain approval for the attempted valid purchase, the customer immediately recognizes that a problem needs to be addressed by contacting the customer's financial institution. If the customer's financial institution provides information about the purchase that resulted in the most recent deactivation of the account, the customer can recognize that a fraudulent purchase was made, attempt to prevent the fraudulent transfer of funds, and possibly arrange for the merchandise or service ordered by the perpetrator to be withheld.

The scenario presented in the example above is unlikely because the fraudulent purchaser completes a purchase within the relatively brief time period during which the credit card account is activated. It is further unlikely because on-line financial transactions are commonly protected by SSL, making it virtually impossible for a perpetrator to capture, decipher, and use the customer's activated credit card account before the customer completes the valid purchase.

In a more likely scenario, a perpetrator obtains the customer's credit card information some time after a valid purchase by gaining access to the merchant's unit where such information is stored. In this case, the present invention thwarts the perpetrator's attempt to make a fraudulent purchase because the MUTE window had been closed automatically after the valid purchase was completed, causing the credit card account to be inactive and unavailable for use. Thus, no approval code is transmitted as a result of the attempted fraudulent purchase.

Although in the examples described herein, transactions included Internet-based credit card transactions between customers and merchants, other embodiments are possible. For example, a transaction could be non-Internet based, such as an in-store or telephone purchase. Further, other embodiments can include other types of transaction accounts, such as debit card and stock trading accounts. Still further, in place of customers, other examples can include owners, holders, users, and other entities who are authorized to use transaction account information. Instead of merchants, other examples can include recipients of transaction account information.

Further, in the embodiments described above, transaction account activation is managed to protect against fraudulent purchases, but other examples can be contemplated. In one embodiment, the MUTE window technique can facilitate the prevention of any misuse of transaction account information, including, for example, the inadvertent or unauthorized alteration of data.

Still further, in another example, the account can be temporarily available for a defined window (e.g., a time period) and the account can also be limited by other criteria, such as restricting purchases to maximum or specific monetary amounts, or to specified geographic regions, merchants, goods and services; etc. In another example, the customer can deactivate the transaction account manually, by contacting the customer's financial institution via a secure connection, such as the secure connections described above in relation to activating the transaction account. Yet further, the defined window can be set by an entity other than the user, such as, for instance, the financial institution.

Yet further, in the embodiments described above, a customer manually sets the secure access to the customer's financial institution unit to activate a transaction account, but this is only one example. In one embodiment, the customer's financial institution unit is contacted automatically when the customer engages in a predefined set of actions (e.g., the customer elects to make an Internet-based credit card purchase). Browser software or another application used to access websites could be modified to recognize that a credit card purchase is about to occur and contact the customer's financial institution unit to activate the transaction account. This automatic contact significantly reduces the MUTE window's duration and thus improves transaction account security.

Additionally, the timing of activation and deactivation of transaction accounts as provided in the descriptions with respect to FIGS. 4a and 4b are intended to be examples only. Other examples are possible, including, but not limited to, activating the transaction account prior to the customer's election to make an on-line purchase or prior to establishing a shopping session with a merchant. As further examples, deactivating the transaction account can occur before the merchant notifies the customer of the approved transaction, before the customer's financial institution unit communicates an approval code, or after the funds are transferred to the merchant's financial institution.

Moreover, the level of transaction account security offered by the examples described above may be enhanced in other embodiments. For example, SSL can be used in conjunction with the present invention to protect transmissions of transaction account information from interception by unauthorized parties. As another example, the customer's financial institution may notify the customer after a transaction is successfully completed or disallowed by transmitting transaction information (e.g., by email). As a further example, attempts to access a transaction account while no MUTE window exists can be counted and the transaction account owner can be notified of the unauthorized attempts. As a still further example, limited-use credit card numbers (e.g., a unique credit card number for each purchase) can be used to allow longer MUTE windows during which multiple outstanding transactions can be in progress. Either manually or automatically, unique suffix or prefix codes can be added to a base code within the transaction account information (e.g., create a unique account specific credit card number). The unique suffix or prefix can indicate for whom the purchase is made. By adding this scheme to the alteration of the MUTE window by limiting the amount of the purchase, an equivalent of an electronic gift certificate is generated.

In one aspect of the present invention, a transaction account card is provided that includes, for instance, an account identifier. The account identifier corresponds to a transaction account that is capable of being temporarily activated for a defined window one or more times within a life of the transaction account. That is, the account may be temporarily activated, then deactivated, and then temporarily activated, again, and so on, during the life of the account. This card may be created using techniques similar to creating credit cards or other cards. It may or may not include storage means, such as magnetic tape, to include identifying information.

The present invention can be included, for example, in an article of manufacture (e.g., one or more computer program products) having, for instance, computer usable media. This media has embodied therein, for instance, computer readable program code means for providing and facilitating the capabilities of the present invention. The article of manufacture can be included as part of the computer system or sold separately.

Additionally, at least one program storage device readable by machine, tangibly embodying at least one program of instructions executable by the machine, to perform the capabilities of the present invention, can be provided.

The flow diagrams depicted herein are provided by way of example. There may be variations to these diagrams or the steps (or operations) described herein without departing from the spirit of the invention. For instance, in certain cases, the steps may be performed in differing order, or steps may be added, deleted or modified. All of these variations are considered a part of the present invention as recited in the appended claims.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of managing activation of transaction accounts, said method comprising:
activating a transaction account to enable use of said transaction account, wherein said transaction account is temporarily available for a defined window; and
deactivating the transaction account, in response to being outside the defined window.

2. The method of claim 1, wherein said temporarily available is for a period of time less than a lifetime of the transaction account.

3. The method of claim 1, wherein the defined window is based on one or more criteria specified by a user of the transaction account.

4. The method of claim 1, wherein the defined window comprises a period of time.

5. The method of claim 1, further comprising limiting use of the transaction account, said limiting being based on one or more of the following criteria:
(a) a maximum monetary amount;
(b) a specific monetary amount;
(c) a geographic region in which said transaction account is to be applied;
(d) a merchant to which said transaction account is to be applied;
(e) a type of good to which said transaction account is to be applied; and
(f) a type of service to which said transaction account is to be applied.

6. The method of claim 1, wherein the defined window comprises completion of a transaction, and wherein said deactivating is automatically performed after the transaction is complete.

7. The method of claim 1, further comprising notifying an owner of the transaction account of transaction information, wherein said transaction information includes at least one of approved and disallowed transactions.

8. The method of claim 1, wherein the transaction account is located on at least one first computing unit, and wherein at least one of the activating and deactivating comprises using, by a user of the transaction account, a second computing unit remote from and in communication with the at least one first computing unit.

9. A method of managing activation of transaction accounts, said method comprising:
activating a transaction account to enable use of the transaction account;
temporarily deactivating the transaction account; and
repeating said activating and said temporarily deactivating one or more times within a life of the transaction account.

10. A system of managing activation of transaction accounts, said system comprising:
means for activating a transaction account to enable use of said transaction account, wherein said transaction account is temporarily available for a defined window; and
means for deactivating the transaction account, in response to being outside the defined window.

11. The system of claim 10, wherein said temporarily available is for a period of time less than a lifetime of the transaction account.

12. The system of claim 10, wherein the defined window is based on one or more criteria specified by a user of the transaction account.

13. The system of claim 10, wherein the defined window comprises a period of time.

14. The system of claim 10, further comprising limiting use of the transaction account, said limiting being based on one or more of the following criteria:
(a) a maximum monetary amount;
(b) a specific monetary amount;
(c) a geographic region in which said transaction account is to be applied;
(d) a merchant to which said transaction account is to be applied;
(e) a type of good to which said transaction account is to be applied; and
(f) a type of service to which said transaction account is to be applied.

15. The system of claim 10, wherein the defined window comprises completion of a transaction, and wherein said means for deactivating comprises means for automatically performing the deactivating after the transaction is complete.

16. The system of claim 10, wherein the transaction account is located on at least one first computing unit, and wherein at least one of the means for activating and the means for deactivating comprises a second computing unit remote from and in communication with the at least one first computing unit.

17. The system of claim 10, further comprising a means for notifying an owner of the transaction account of transaction information, wherein said transaction information includes at least one of approved and disallowed transactions.

18. A system of managing activation of transaction accounts, said system comprising:
a first unit to activate a transaction account to enable use of said transaction account, wherein said transaction account is temporarily available for a defined window; and
a second unit to deactivate the transaction account, in response to being outside the defined window.

19. The system of claim 18, wherein the first unit and the second unit are the same unit.

20. The system of claim 18, wherein the first unit is different from the second unit.

21. The system of claim 18, wherein the transaction account is located on at least one third unit, and wherein the first unit is remote and in communication with the at least one third unit.

22. The system of claim 18, wherein the first unit comprises a web browser capable of automatically activating the transaction account.

23. At least one program storage device readable by a machine tangibly embodying at least one program of instructions executable by the machine to perform a method of managing activation of transaction accounts, said method comprising:
activating a transaction account to enable use of said transaction account, wherein said transaction account is temporarily available for a defined window; and
deactivating the transaction account, in response to being outside the defined window.

24. The at least one program storage device of claim 23, wherein said temporarily available is for a period of time less than a lifetime of the transaction account.

25. The at least one program storage device of claim 23, wherein the defined window is based on one or more criteria specified by a user of the transaction account.

26. The at least one program storage device of claim 23, wherein the defined window comprises a period of time.

27. The at least one program storage device of claim 23, further comprising limiting use of the transaction account, said limiting being based on one or more of the following criteria:
(a) a maximum monetary amount;
(b) a specific monetary amount;
(c) a geographic region in which said transaction account is to be applied;
(d) a merchant to which said transaction account is to be applied;
(e) a type of good to which said transaction account is to be applied; and
(f) a type of service to which said transaction account is to be applied.

28. The at least one program storage device of claim 23, wherein the defined window comprises completion of a transaction, and wherein said deactivating is automatically performed after a transaction is complete.

29. The at least one program storage device of claim 23, further comprising notifying an owner of the transaction account of transaction information, wherein said transaction information includes at least one of approved and disallowed transactions.

30. A transaction account card comprising:
an account identifier, said account identifier corresponding to a transaction account that is capable of being temporarily activated for a defined window one or more times within a life of the transaction account.
